(19) United States
(12) Patent Application Publication
(10) Pub. No.: US 2021/0129869 A1
(43) Pub. Date: May 6, 2021

(54) INTELLIGENT DRIVING CONTROL METHODS AND APPARATUSES, VEHICLES, ELECTRONIC DEVICES, AND STORAGE MEDIA

(71) Applicant: Shanghai SenseTime Intelligent Technology Co., Ltd., Shanghai (CN)

(72) Inventor: Sichang SU, Shanghai (CN)

(21) Appl. No.: 17/146,001

(22) Filed: Jan. 11, 2021

Related U.S. Application Data
(63) Continuation of application No. PCT/CN2019/098577, filed on Jul. 31, 2019.

(30) Foreign Application Priority Data
Aug. 29, 2018 (CN) 201810995899.3

(51) Int. Cl. B60W 60/00; G05D 1/00

(52) U.S. Cl. CPC B60W 60/0059; G05D 1/0061; B60W 2552/53; B60W 2420/42; B60W 2555/20; B60W 2552/15; B60W 2554/406; B60W 2554/4029

(57) ABSTRACT

Intelligent driving control methods and apparatuses, vehicles, electronic devices, and storage media are provided. The method includes: obtaining a confidence degree of a detection result for at least one vehicle driving environment according to data collected by a sensor arranged in a vehicle; determining a driving safety level corresponding to the vehicle according to mapping relationships between confidence degrees and driving safety levels; and performing an intelligent driving control on the vehicle according to the determined driving safety level.

The present disclosure a continuation application of International Patent Application No. PCT/CN2019/098577, filed on Jul. 31, 2019, which is based on and claims priority to and benefit of Chinese Patent Application No. CN 201810995899.3, filed with the China National Intellectual Property Administration (CNIPA) on Aug. 29, 2018. The content of all of the above-identified applications is incorporated herein by reference in their entirety.

### TECHNICAL FIELD

The present disclosure relates to intelligent driving technology, and in particular, to an intelligent driving control method and apparatus, vehicle, electronic device and storage medium.

### BACKGROUND

Automatic driving technologies are gradually mature. Many vehicle types are provided with auxiliary or automatic driving technologies, but so far there are still various problems in the automatic driving technologies. In the case of complicated vehicle conditions, manual supervision is required, and even manual management is required. Safety level determination for automatic driving is an important subject in the automatic driving technology.

### SUMMARY

Embodiments of the present disclosure provide an intelligent driving control technology.

According to one aspect of embodiments of the present disclosure, an intelligent driving control method is provided, which includes:

obtaining a confidence degree of a detection result for at least one vehicle driving environment according to data collected by a sensor arranged in a vehicle;

determining a driving safety level corresponding to the vehicle according to mapping relationships between confidence degrees and driving safety levels; and

performing an intelligent driving control on the vehicle according to the determined driving safety level.

According to another aspect of embodiments of the present disclosure, an intelligent driving control apparatus is provided, which includes:

a confidence degree obtaining unit, configured to obtain a confidence degree of a detection result for at least one vehicle driving environment according to data collected by a sensor arranged in a vehicle;

a safety level determining unit, configured to determine a driving safety level corresponding to the vehicle according to mapping relationships between confidence degrees and driving safety levels; and

an intelligent driving unit, configured to perform an intelligent driving control on the vehicle according to the determined driving safety level.

According to another aspect of embodiments of the present disclosure, a vehicle is provided, which includes the intelligent driving control apparatus according to any of the above embodiments.

According to another aspect of embodiments of the present disclosure, an electronic device is provided, which includes the intelligent driving control apparatus according to any of the above embodiments.

According to another aspect of embodiments of the present disclosure, an electronic device is provided, which includes a memory storing executable instructions; and

a processor to communicate with the memory to execute the executable instructions to complete operations of the intelligent driving control method according to any of the above embodiments.

According to another aspect of embodiments of the present disclosure, a computer storage medium for storing computer-readable instructions is provided, wherein when the computer-readable instructions are executed, operations of the intelligent driving control method according to any of the above embodiments are performed.

According to another aspect of embodiments of the present disclosure, a computer program product comprising computer-readable codes, wherein when the computer-readable codes are driving on a device, a processor in the device executes instructions for implementing the intelligent driving control method according to any of the above embodiments.

Based on intelligent driving control methods and apparatuses, vehicles, electronic devices and storage media provided by the above embodiments of the present disclosure, a confidence degree of a detection result for at least one vehicle driving environment is obtained according to data collected by a sensor arranged in the vehicle; a driving safety level for the vehicle is determined according to mapping relationships between confidence degrees and driving safety levels; and an intelligent driving control is performed on the vehicle according to the determined driving safety level. By combining the detection result for the at least one vehicle driving environment, a current safety state is evaluated and the driving mode of the vehicle is controlled according to the obtained driving safety level, thereby improving the safety and convenience of the vehicle.

The technical solution of the present disclosure will be further described in detail with the attached drawings and embodiments.

### BRIEF DESCRIPTION OF THE DRAWINGS

The accompanying drawings, which form a part hereof, describe embodiments of the disclosure, and together with the description serve to explain the principles of the disclosure.

The present disclosure can be more clearly understood from the following detailed description with reference to the accompanying drawings.

FIG. 1 is a flowchart of an intelligent driving control method provided by embodiments of the present disclosure.

FIG. 2 is a flowchart of a driving safety level control in an example of an intelligent driving control method provided by embodiments of the present disclosure.

FIG. 3 is a schematic structural diagram of an intelligent driving control apparatus provided by embodiments of the present disclosure.

FIG. 4 is a schematic structural diagram of an electronic device suitable for implementing a terminal device or a server provided by embodiments of the present disclosure.

### DETAILED DESCRIPTION OF THE EMBODIMENTS

Various exemplary embodiments of the present disclosure will now be described in detail with reference to the accompanying drawings. It should be noted that the relative arrangements, numerical expressions, and numerical values of the components and steps set forth in these embodiments do not limit the scope of the present disclosure unless otherwise specified.

Meanwhile, it should be understood that, for convenience of description, the dimensions of the various parts shown in the drawings are not drawn according to actual proportional relationships.

The following description of at least one exemplary embodiment is practically merely illustrative, and is not intended to limit the present disclosure and its application or use.

Techniques, methods, and devices known to those of ordinary skill in the relevant art may not be discussed in detail, but where appropriate, the techniques, methods, and devices should be considered as part of the description.

It should be noted that like reference signs and letters denote like items in the following figures, and therefore, once a certain item is defined in one figure, no further discussion thereof is needed in the following figures.

Embodiments of the present disclosure may be applied to a computer system/server, which may operate with numerous other general-purpose or special-purpose computing systems, environments or configurations. Examples of well-known computing systems, environments and/or configurations suitable for use with the computer system/server include, but not limited to, personal computer systems, server computer systems, thin clients, thick clients, hand-held or laptop devices, microprocessor-based systems, set-top boxes, programmable consumer electronics, network personal computers, minicomputer systems, mainframe computer systems, and distributed cloud computing technology environments including any of the above, and the like.

The computer system/server may be described in the general context of computer system-executable instructions, such as program modules, executed by the computer system. In general, program modules may include routines, programs, target programs, components, logic, data structures, etc. that perform particular tasks or implement particular abstract data types. The computer system/server may be implemented in a distributed cloud computing environment in which tasks are performed by a remote processing device linked through a communication network. In the distributed cloud computing environment, the program modules may be located on a storage medium of a local or remote computing system including a storage device.

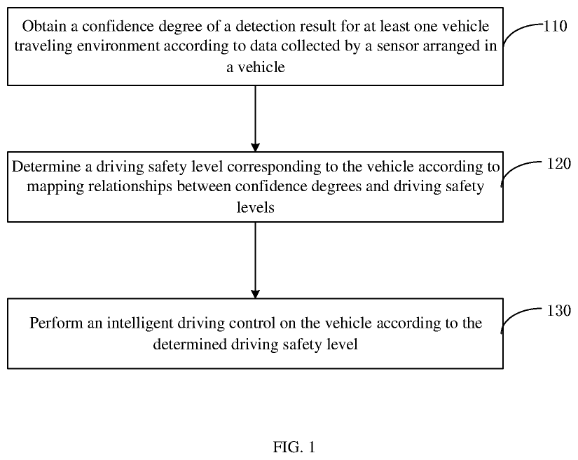

FIG. 1 is a flowchart of an intelligent driving control method provided by embodiments of the present disclosure. As shown in FIG. 1, the method in this embodiment includes steps 110 to 130.

At step 110, a confidence degree of a detection result for at least one vehicle driving environment is obtained according to data collected by a sensor arranged in the vehicle.

In this embodiment, by analyzing at least one vehicle driving environment corresponding to the vehicle, the influence of various vehicle traveling environments on the driving situation of the vehicle is comprehensively considered, and thus the accuracy of the obtained driving safety level is improved.

In an example, the step S110 can be performed by the processor calling the corresponding instructions stored in the memory, or can be performed by a confidence degree obtaining unit 31 run by the processor.

At step 120, a driving safety level for the vehicle is determined according to mapping relationships between confidence degrees and driving safety levels.

In some embodiments, based on the confidence degrees of the detection results for at least one vehicle driving environment, at least one driving safety level can be determined according to the mapping relationships between confidence degrees and driving safety levels. These driving safety levels respectively correspond to different vehicle driving environments. To improve the safety of vehicle driving, a lower driving safety level (for example, the lowest driving safety level) in the at least one driving safety level may be used as the driving safety level for the vehicle. The vehicle is controlled and adjusted according to the lower driving safety level, thereby improving the safety of vehicle driving.

In an example, the step S120 can be performed by the processor calling the corresponding instructions stored in the memory, or can be performed by a safety level determination unit 32 run by the processor.

At step 130, intelligent driving control is performed on the vehicle according to the determined driving safety level.

The vehicle is subjected to intelligent driving control by the driving safety level, so that the vehicle can execute a relatively suitable driving mode. For example, when automatically driving can be performed on the vehicle, the vehicle is driven automatically, to save the energy of the driver; and when the vehicle is not suitable for automatic driving, the safety of the vehicle driving can be improved by manual driving or auxiliary driving.

In an example, the step S130 can be performed by the processor calling the corresponding instructions stored in the memory, or can be performed by an intelligent driving unit 33 run by the processor.

Based on the intelligent driving control method provided by the above embodiments of the present disclosure, a confidence degree of a detection result for at least one vehicle driving environment is obtained according to data collected by a sensor arranged in the vehicle; a driving safety level for the vehicle is determined according to a mapping relationship between a confidence degree and a driving safety level; and intelligent driving control is performed on the vehicle according to the determined driving safety level. By combining the detection results for the at least one vehicle driving environment, a current safety state is evaluated and the driving mode of the vehicle is controlled according to the obtained driving safety level, thereby improving the safety and convenience of the vehicle.

In some embodiments, the method provided by embodiments of the present disclosure further includes: displaying information associated with the determined driving safety level, and/or, sending the information associated with the determined driving safety level.

To facilitate the user to have an intuitive feeling of the driving safety level, in this embodiment, information associated with the driving safety level can be displayed through a display device such as a display screen arranged in the vehicle or a mobile phone display screen. In some embodiments, the information associated with the driving safety level includes, but not limited to, a driving mode corresponding to the driving safety level, a camera picture corresponding to the driving safety level, etc. In the embodiment, sending information associated with the driving safety level can further be included. In some embodiments, information associated with the driving safety level can be sent to a device (for example, a terminal such as a mobile phone and a computer) predetermined by the user. Information associated with the driving safety level is displayed and viewed through the device. The device may include a device arranged in the vehicle or a remote device, which enables a predetermined user to view the information associated with the driving safety level. In this way, the handling efficiency of the sudden situation of the vehicle can be improved and the occurrence of accidents can be reduced.

In some embodiments, step 120 can include respectively mapping the confidence degree of the detection result for at least one vehicle driving environment according to the mapping relationships between confidence degrees and driving safety levels to obtain at least one driving safety level; and

taking a lowest driving safety level in the at least one driving safety level as the driving safety level for the vehicle.

In this embodiment, for each of the at least one vehicle driving environment, the confidence degree of the detection result for the vehicle driving environment is mapped according to the defined mapping relationship between a confidence degree and driving a safety level to obtain the driving safety level for the vehicle driving environment. In this case, if a higher driving safety level is taken as the driving safety level for the vehicle, the automatic driving may be performed due to the driving safety level is relatively high, but the automatic driving cannot handle situations in the relatively low driving safety level, thereby causing the vehicle to risk. Therefore, in the embodiment, to improve the safety of the vehicle driving, a lower driving safety level (such as the lowest driving safety level) is used as the driving safety level for the vehicle. For example, a range of the value of the confidence degree is 0 to 1 through processing. When the driving safety levels include the following four levels: low safety level, medium-low safety level, medium safety level and high safety level, and the low safety level, the medium-low safety level, the medium safety level and the high safety level respectively corresponds to 1, 2, 3, 4 level values, the corresponding driving safety level is obtained by the following formula (1) based on confidence level mapping:

for (x=0˜M) M represents the number of vehicle driving environments

$${Level}_{x} = \frac{A}{{Conf}_{x}} + B \qquad formula ( 1 )$$

wherein A and B are fixed coefficients obtained by adjusting parameters, Confₓ represents the confidence level corresponding to various vehicle driving environment, and Levelₓ represents the driving safety level. Levelₓ is put into a set K₁, which stores the driving safety level corresponding to each driving scene. Because the influence of each driving scene on automatic driving safety is independent of each other, and the low driving safety level is the bottleneck of automatic driving safety, the minimum value in the set K₁ is taken as the safety level for automatic driving: Level_{safe}=min {K₁}. The obtained Level_{safe} is the safety level for automatic driving.

In some embodiments, intelligent driving control includes: switching control of driving modes for the vehicle, wherein the driving modes include at least two of: an automatic driving mode, a manual driving mode, or an auxiliary driving mode.

In some embodiments, the automatic driving mode does not require manual participation, environmental observation and vehicle control are completed automatically by machine, and since manual participation in vehicle control is not required, convenient services for drivers are provided. The manual driving mode is full manual control mode. In the manual driving mode, the vehicle is controlled by operation and observation of the driver, functions from observing the surrounding environment to controlling vehicle driving and other functions are all done manually. The auxiliary driving mode can include automatic information collection and manual control of the vehicle, which has more flexibility than the automatic driving mode. The manual driving mode and the auxiliary driving mode can be used when the driving safety level is relatively low, but the automatic driving mode can only be applied when the driving safety level is relatively high. For example, if the current road condition is relatively complicated and the automatic driving mode cannot be handled correctly, the driver is prompted to switch to the manual driving mode or the auxiliary driving mode, or the driver actively switches the driving mode to the automatic driving mode, the manual driving mode or the auxiliary driving mode.

In some embodiments, the driving safety levels include at least two of: low safety level, medium-low safety level, medium safety level, or high safety level.

In the embodiment, the above four kinds of driving safety levels are listed according to safety levels. The safety of the low safety level is the lowest, and the safety of the medium-low safety level is slightly higher than the safety level of the low safety level. Usually, in the case of these two safety levels, the automatic driving mode is not applicable, and it is necessary to switch to the manual driving mode to control the vehicle. Of course, in the case of these two safety levels, if the driver operates manually to switch the driving mode to the automatic driving mode, the vehicle may execute the automatic driving mode, and correspondingly, a warning notification may be sent out to notify the driver that the current safety level is not applicable to the automatic driving mode. The safety of the medium safety level is higher than the safety of the medium-low safety level, and the safety of the high safety level is higher. In the case of the two safety levels, the vehicle may be controlled by the automatic driving mode, or the manual driving mode may be adopted based on the operation of the driver. To complete switching control of the driving mode of the vehicle, the driving safety levels include at least two kinds of the above four kinds.

In some embodiments, step 130 can include:

in response to the driving safety level being a low safety level or a medium-low safety level, controlling the vehicle to execute a manual driving mode, and/or sending out prompt information, and controlling the vehicle to execute the manual driving mode, an auxiliary driving mode, or an automatic driving mode in accordance with feedback information; and/or

in response to the driving safety level being a medium safety level or a high safety level, controlling the vehicle to execute the automatic driving mode, or controlling the vehicle to execute the manual driving mode or the auxiliary driving mode in accordance with feedback information.

In some embodiments, the driving safety level is displayed to the driver via a vehicle control panel. In a case where the driving safety level is low or medium-low, the driving mode is directly switched to the manual mode and warn information is sent out. In a case where the driving safety level is medium or high, there is no warning and the vehicle is controlled to be switched to the automatic driving mode. Of course, no matter what the driving safety level is, the driving mode may be manually switched according to manual determination, that is, the driving mode is switched to the manual driving mode, the auxiliary driving mode or the automatic driving mode according to user control.

In some embodiments, the vehicle driving environment can include, but not limited to, at least one of: road, object, scene, or the number of obstacles.

The detection result for the vehicle driving environment includes at least one of: road segmentation result, object detection result, scene identification result, or obstacle number detection result.

When the vehicle is driving or moving on the road, the safety of the vehicle is mainly affected by a road condition, nearby pedestrian, vehicles and other objects, current weather condition, and obstacles in front of the vehicle. Once one of these cases has problem, it indicates that the current safety level of the vehicle is decreased. Therefore, the driving safety level depends on the environmental factor with the lowest safety level in the vehicle driving environment. The above four vehicle driving environments listed in the embodiment are not intended to limit kinds of vehicle driving environments. The vehicle driving environment may further include other information. The present disclosure does not limit which information a particular vehicle driving environment includes.

In some embodiments, the road segmentation result includes at least one of: lane line segmentation result, stop line segmentation result, or road intersection segmentation result.

The traffic rule needs to be observed in the process of driving. As part of the traffic rules, the segmentation results of lane line, stop line and road intersection have a certain impact on the safe driving of the vehicle. When the confidence degree of the road segmentation result is relatively low, it indicates that the road segmentation result is not obtained and can be considered that the current road identification is obstructed, and at this time, if the vehicle is controlled by the automatic driving mode, a threat will be posed to the vehicle safety, which is disadvantageous for safe driving.

In some embodiments, the object detection result includes at least one of: pedestrian detection result, motor vehicle detection result, non-motor vehicle detection result, obstacle detection result, or dangerous object detection result.

In the process of driving, the vehicle can encounter multiple objects, such as pedestrians, motor vehicles, non-motor vehicles, obstacles, dangerous objects and so on. To drive safely, it is necessary to detect all categories of objects. When the confidence degree of the object detection result is relatively low, the camera perception may be obstructed or there may be no other objects on the road. At this time, these objects need to be manually determined. In this embodiment, when the camera perception is obstructed, the driving mode is switched according to specific conditions, thereby improving the safety of vehicle driving.

In some embodiments, the scene identification result includes at least one of: rainy day identification result, fog day identification result, sandstorm identification result, flood identification result, typhoon identification result, cliff identification result, steep slope identification result, mountain risk road identification result, or light identification result.

In the process of driving, the vehicle may be affected by scenes such as weather and light. For example, weather such as rainy and fog may result in a reduction in identification level and this case belongs to a scene other than the automatic driving scene. In these scenes, the driving safety levels are relatively low, and the automatic driving is not applicable. To improve the safety of the vehicle driving, the vehicle driving mode may be switched to the manual driving mode or the auxiliary driving mode. In this embodiment, the vehicle is intelligently controlled by combining the scene identification result, thereby extending the applicable scene range of the intelligent driving control method provided by the embodiments. In this way, the intelligent driving control method provided by the embodiments can improve the safety of vehicle driving in various scenarios.

In some embodiments, the obstacle number detection result includes at least one of: the number of detected pedestrians, the number of detected motor vehicles, the number of detected non-motor vehicles, or the number of detected other objects.

Obstacles may include, but not limited to, pedestrians, vehicles, non-motor vehicles, other objects, etc. Other objects may include, but not limited to, fixed buildings, temporary stacking of items, etc. In general, the more obstacles in front of the vehicle, the more complicated the road conditions, that is, the lower the safety level. Since the sizes of different obstacles (for example, pedestrian and vehicle) are different, if all the obstacles are taken as the same category of target to perform detection, the number obtained by the detection will be affected. In this embodiment, by respectively detecting the number of obstacles belonging to different categories, the accuracy of the number of detected obstacles belonging to each category is improved, and thus the accuracy of the obstacle number detection result is improved.

In some embodiments, step 110 can include:

respectively detecting at least one vehicle driving environment according to data collected by a sensor arranged in the vehicle to obtain a confidence degree of at least one detection result, each vehicle driving environment corresponding to a confidence degree of at least one detection result; and

for each vehicle driving environment, determining the confidence degree of the detection result for the vehicle driving environment from the confidence degree of at least one detection result corresponding to the vehicle driving environment.

In some embodiments, the sensor may include, but not limited to, a camera, and the collected data may be images, for example, when the camera is set in the front of the vehicle, the collected images are images in front of the vehicle. An image of the vehicle-related environmental information can be obtained with the sensor. Alternatively, the images can be processed by a deep neural network to obtain a confidence degree for each vehicle driving environment. The confidence degree for the vehicle driving environment indicates a probability that a particular situation occurs in the vehicle driving environment, for example, in a case that a lane line, a stop line, or a road intersection is not identified in road information, respective confidence degrees are respectively obtained, and the maximum confidence degree in the respective confidence degrees is taken as the confidence degree of the road information, that is, the confidence degree to which the current road identification is obstructed can be determined. When the likelihood that the road identification is obstructed is larger, it indicates that the safety level is lower.

In some embodiments, when the detection result for the vehicle driving environment includes at least one of: road segmentation result, object detection result, or scene identification result;

respectively detecting at least one vehicle driving environment according to data collected by the sensor arranged in the vehicle to obtain the confidence degree of at least one detection result includes:

processing the data collected by the sensor by using a deep neural network to obtain a detection result for the at least one vehicle driving environment;

for each of the at least one vehicle driving environment, determining at least one initial confidence degree of each detection result based on the detection result for the vehicle driving environment, each of the at least one vehicle driving environment corresponding to at least one detection result;

obtaining an average confidence degree of the detection result within a defined time period based on the at least one initial confidence degree of the detection result; and

determining the confidence level for each detection result based on the average confidence level.

For each different vehicle driving environment, the corresponding confidence degree can be obtained. In this embodiment, the corresponding confidence degree for at least one of the road segmentation result, object detection result, scene identification result is determined. The higher the confidence degree of road segmentation result, the lower the probability indicating that the road segmentation result is identified and the lower the driving safety level. The higher the confidence degree of object detection result, the lower the probability indicating that objects are detected and the lower the driving safety level. The higher the confidence degree of scene identification result, the higher the probability indicating that scenes are detected and the lower the driving safety level. The confidence degree may indicate which condition in the current vehicle driving environment of the vehicle, for example, the road identification being obstructed, the occurrence of pedestrians, vehicles and other objects, or scene information identification being relatively difficult, is relatively severe. Each vehicle driving environment can obtain a corresponding safety level, the more severe the problem and the lower the safety level. Each vehicle driving environment corresponds to at least one detection result, and to obtain a relatively accurate confidence degree, one of at least one confidence degree may be used as the confidence degree of the driving environment, or an average value of a plurality of confidence degrees may be used as the confidence degree of the driving environment.

For example, in the embodiment, initial confidence degrees of road information are evaluated by an average confidence degree, and a sliding window of length T_{slide} is configured. The initial confidence degrees for the road information within the time window are integrated to obtain a value. The value is divided by the time window length to obtain an average confidence degree avr_Confᵢ. The formula (2) for calculating avr_Confᵢ is shown as follows:

$${avr\_Conf}_{i} = \frac{1}{{t}_{1} - {t}_{0}} {\int }_{{t}_{0}}^{{t}_{1}} {Conf}_{i} ( t ) i = 0 ∼ N , {T}_{slide} = {t}_{1} - {t}_{0} \qquad formula ( 2 )$$

wherein t indicates the time, T_{slide}=t₁−t₀ indicates a length of the sliding window, Confᵢ(t) indicates an initial confidence corresponding to the i-th road information at the time t, and i indicates the i-th road information in the road information, i being any integer from 0 to N. Corresponding to the above embodiments, the road information includes three kinds of road information: lane line, stop line and road intersection, and in this case, i is an integer from 0 to 2. If avr_Confᵢ≠0, a weighted confidence degree Wᵢ*avr_{conf}_{ᵢ} is added into a set K₂. The set K₂ includes respective average confidence degree corresponding to the (N+1) kinds of road information.

In some embodiments, for each vehicle driving environment, determining the confidence degree of the detection result for the vehicle driving environment from the confidence degree of the at least one detection result corresponding to the vehicle driving environment includes:

for each vehicle driving environment, determining a maximum in the confidence degree of the at least one detection result corresponding to the vehicle driving environment as the confidence degree of the detection result for the vehicle driving environment.

Obtaining the maximum in confidence degrees can be implemented by the following formula (3), and the maximum in the set K₂ is taken as the confidence degree for the vehicle driving environment:

Confₓ=max{K₂} Formula (3))

where, Confₓ indicates the confidence degree of the road information, and each element in the set K₂ is the respective average confidence degree corresponding to the 0-th road information to the N-th road information.

In some embodiments, the detection result for the vehicle driving environment includes obstacle number detection result;

respectively detecting at least one vehicle driving environment according to the data collected by the sensor arranged in the vehicle to obtain the confidence degree of at least one detection result includes:

processing the data collected by the sensor by using a deep neural network to obtain at least one obstacle number detection result;

based on each of the at least one obstacle number detection result, determining a number of obstacles belonging to each category;

for each category, averaging the number of obstacles belonging to the category within a defined time period to obtain an average number of obstacles belonging to the category; and

obtaining a confidence degree corresponding to each of the at least one obstacle number detection result based on the average number.

Obtaining the number of obstacles belonging to each category can be implemented by the following formula (4). A sliding window with a length T_{slide} is set, and the number of obstacles belonging to the category in the time window can be counted:

for (j=0˜N)

for (i=0˜n)

if Confᵢⱼ>ConfThrⱼ;

then Numⱼ=Numⱼ+1 Formula (4)

wherein ConfThr₁ indicates a confidence degree threshold for the category j, i indicates a ordinal number of an object belonging to the category, j indicates an ordinal number of the category, Con fᵢⱼ indicates a confidence degree of the appearance of an i-th object belonging to the category j, and Num₁ indicates the number of objects belonging to the category j.

The average number (or average quantity) of obstacles belonging to each category can be obtained based on the following formula (5). The number of objects belonging to the category j can be integrated and then is divided by the length of the time window. The average number avr_Numⱼ of objects belonging to the category j in the time window is obtained:

$${avr\_Num}_{j} = \frac{1}{{t}_{1} - {t}_{0}} {\int }_{{t}_{0}}^{{t}_{1}} {Num}_{j} ( t ) j = 0 ∼ N , {T}_{slide} = {t}_{1} - {t}_{0} \qquad Formula ( 5 )$$

Where, t indicates the time, T_{slide}=t₁−t₀ indicates the length of the sliding window, Numⱼ(t) indicates the number of obstacles belonging to the j-th category at time t, j indicates the category of an obstacle and there are 0 to N obstacle categories. For example, for the above embodiments, there are three categories (from 0-th category to 2-th category): pedestrians, vehicles, non-motor vehicles.

In some embodiments, obtaining the confidence degree corresponding to each obstacle category based on the average number includes:

dividing the average number by a defined number threshold for an obstacle category corresponding to the average number to obtain a quotient corresponding to the obstacle category; and

numerically limiting the quotient corresponding to the obstacle category to obtain the confidence degree corresponding to each obstacle category.

Alternatively, the quotient corresponding to an obstacle category can be numerically limited by a constraint function. The constraint function limits a value to be 0 to 1. The confidence degree corresponding to each obstacle category can be obtained by the following formula (6) based on the average number. The average number is weighted by an inverse proportional function and then mapped to the confidence degree:

$${Conf}_{j} = {Clip}_{0}^{1} ( \frac{{avr\_Num}_{j}}{{NumThr}_{j}} ) \qquad Formula ( 6 )$$

where, Clip₀¹(*) indicates the constraint function which is used to limit or constraint a value in parentheses to be 0 to 1. With the constraint function, a value less than 0 is limited to be 0, and a value greater than 1 is limited to be 1. NumThrⱼ indicates the threshold number for the j-th obstacle category. Conf₁ indicates the confidence degree of the j-th obstacle category. If Confⱼ≠0, Confⱼ is added to a set K₃. The set K₃ includes the confidence degree of belonging to each obstacle category.

In some embodiments, for each vehicle driving environment, determining the confidence degree of the detection result for the vehicle driving environment from the confidence degree of the at least one detection result corresponding to the vehicle driving environment including:

for each of the at least one vehicle driving environment, determining a maximum in the confidence degree of the at least one detection result corresponding to the vehicle driving environment as the confidence degree of the detection result for the vehicle driving environment.

In this embodiment, the maximum in the confidence degree of the at least one detection result corresponding to the vehicle driving environment can be obtained by replacing K₂ in the above formula (3) with K₃.

In some embodiments, the sensor includes a camera.

Generally, the sensor arranged in the vehicle includes, but not limited to, a camera, a radar, a GPS (Global Positioning System), a map, an inertial measurement unit, and the like. If the described embodiments of the present disclosure are mainly used to process a captured image, information obtained by other sensors may be used as auxiliary information, or information obtained by other sensors may be ignored. As long as the accurate identification of the driving safety level in the above-described embodiment is reached.

FIG. 2 is a flowchart of a driving safety level control in an example of an intelligent driving control method provided by embodiments of the present disclosure. As shown in FIG. 2, assuming that the vehicle is currently in the automatic driving mode, the safety levels include: a low safety level, a medium-low safety level, a medium safety level and a high safety level. Whether the obtained driving safety level is less than or equal to the medium-low safety level is determined according to the obtained vehicle driving environment. If the obtained driving safety level is less than or equal to the medium-low safety level, the driving mode of the vehicle is switched to the manual driving mode or the auxiliary driving mode. If the obtained driving safety level is higher than the medium-low safety level, the automatic driving mode is maintained.

Persons of ordinary skill in the art may understand that all or part of the steps of the foregoing method embodiments may be implemented by a program instructing relevant hardware, and the foregoing program may be stored in a computer readable storage medium, and when the program is executed, the steps including the foregoing method embodiments are executed. The foregoing storage medium includes various medium that can store program codes, such as a ROM (Read-Only Memory), a RAM (Random Access Memory), a magnetic disk, an optical disk, or the like.

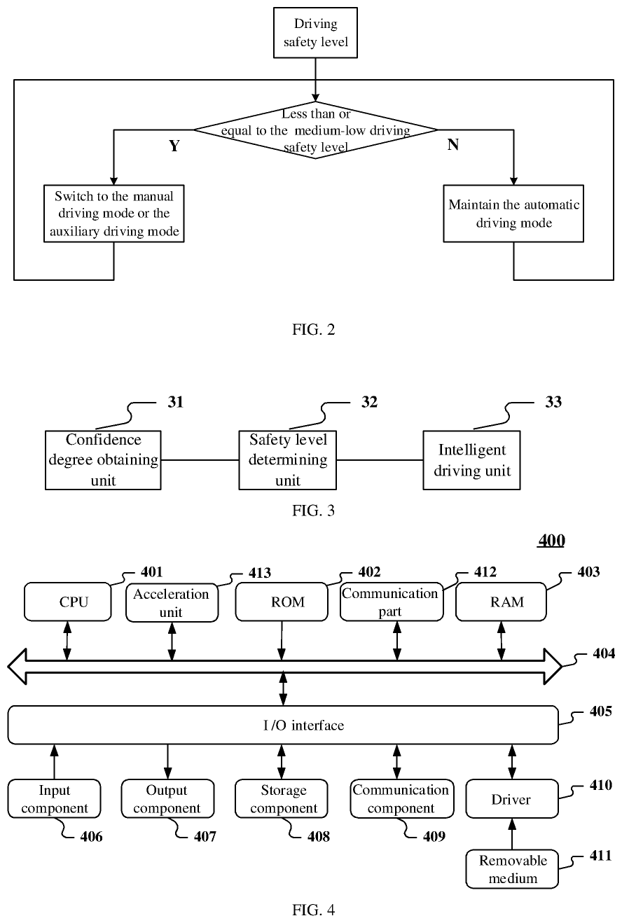

FIG. 3 is a schematic structural diagram of an intelligent driving control apparatus provided by embodiments of the present disclosure. The apparatus provided by the embodiment can be used to implement the above method embodiments of the present disclosure. As shown in FIG. 3, the apparatus in the embodiment includes:

a confidence degree obtaining unit 31, configured to obtain a confidence degree of a detection result for at least one vehicle driving environment according to data collected by a sensor arranged in a vehicle;

a safety level determining unit 32, configured to determine a driving safety level corresponding to the vehicle according to mapping relationships between confidence degrees and driving safety levels; and

an intelligent driving unit 33, configured to perform intelligent driving control on the vehicle according to the determined driving safety level.

Based on intelligent driving control apparatuses provided by the above embodiments of the present disclosure, a confidence degree of a detection result for at least one vehicle driving environment is obtained according to data collected by a sensor arranged in the vehicle; a driving safety level for the vehicle is determined according to mapping relationships between confidence degrees and driving safety levels; and intelligent driving control is performed on the vehicle according to the determined driving safety level. By combining the detection result for the at least one vehicle driving environment, a current safety state is evaluated and the driving mode of the vehicle is controlled according to the obtained driving safety level, thereby improving the safety and convenience of the vehicle.

In some embodiments, the apparatus provided by embodiments of the present disclosure further includes: a relevant information unit configured to display information associated with the determined driving safety level; and/or send the information associated with the determined driving safety level.

To facilitate the user to have an intuitive feeling of the driving safety level, in this embodiment, information associated with the driving safety level can be displayed through a display device such as a display screen arranged in the vehicle or a mobile phone display screen. In some embodiments, the information associated with the driving safety level includes, but not limited to, a driving mode corresponding to the driving safety level, a camera picture corresponding to the driving safety level, etc. In the embodiment, sending information associated with the driving safety level can further be included. In some embodiments, information associated with the driving safety level can be sent to a device (for example, a terminal such as a mobile phone and a computer) predetermined by the user. Information associated with the driving safety level is displayed and viewed through the device. The device may include a device arranged in the vehicle or a remote device, which enables a predetermined user to view the information associated with the driving safety level. In this way, the handling efficiency of the sudden situation of the vehicle can be improved and the occurrence of accidents can be reduced.

In some embodiments, the safety level determining unit 32 is configured to according to the mapping relationships between confidence degrees and driving safety levels, respectively map the confidence degree of the detection result for the at least one vehicle driving environment to obtain at least one driving safety level; and determine a lowest driving safety level in the at least one driving safety level as the driving safety level corresponding to the vehicle.

In this embodiment, according to the defined mapping relationship between a confidence degree and a driving safety level, the confidence degree of the detection result for the at least one vehicle driving environment is respectively mapped to obtain at least one driving safety level. In this case, if a higher driving safety level is taken as the driving safety level for the vehicle, the automatic driving may be performed due to the driving safety level is relatively high, but the automatic driving cannot handle situations in the relatively low driving safety level, thereby causing the vehicle to risk. Therefore, in the embodiment, to improve the safety of the vehicle driving, the lowest driving safety level is used as the driving safety level for the vehicle.

In some embodiments, the intelligent driving control includes: performing switching control of driving modes of the vehicle, wherein the driving modes include at least two of: an automatic driving mode, a manual driving mode or an auxiliary driving mode.

In some embodiments, the driving safety levels include at least two of a low safety level, a medium-low safety level, a medium safety level, or a high safety level.

In some embodiments, the intelligent driving unit 33 is configured to in response to the driving safety level being the low safety level or the medium-low safety level, control the vehicle to be at the manual driving mode, and/or send out a prompt and control the vehicle to be at the manual driving mode, the auxiliary driving mode or the automatic driving mode according to feedback information; and/or

in response to the driving safety level being the medium safety level or the high safety level, control the vehicle to be at the automatic driving mode, or control the vehicle to be at the manual driving mode or the auxiliary driving mode according to feedback information.

In some embodiments, the driving safety level is displayed to the driver via a vehicle control panel. In a case where the driving safety level is low or medium-low, the driving mode is directly switched to the manual mode and warn information is sent out. In a case where the driving safety level is medium or high, there is no warning and the vehicle is controlled to be switched to the automatic driving mode. Of course, no matter what the driving safety level is, the driving mode switching may be manually performed according to manual determination, that is, the driving mode is switched to the manual driving mode, the auxiliary driving mode or the automatic driving mode according to user control.

In some embodiments, the vehicle driving environment comprises at least one of: road, object, scene, or number of obstacles;

the detection result for the vehicle driving environment comprises at least one of: road segmentation result, object detection result, scene identification result, or obstacle number detection result.

When the vehicle is driving or moving on the road, the safety of the vehicle is mainly affected by a road condition, nearby pedestrian, vehicles and other objects, current weather condition, and obstacles in front of the vehicle. Once one of these cases has problem, it indicates that the current safety level of the vehicle is decreased. Therefore, the driving safety level depends on the environmental factor with the lowest safety level in the vehicle driving environment. The above four vehicle driving environments listed in the embodiment are not intended to limit kinds of vehicle driving environments. The vehicle driving environment may further include other information. The present disclosure does not limit which information a particular vehicle driving environment includes.

In some embodiments, the road segmentation result includes at least one of: lane line segmentation results, stop line segmentation results, or road intersection segmentation result.

In some embodiments, the object detection result includes at least one of: pedestrian detection result, motor vehicle detection result, non-motor vehicle detection result, obstacle detection result, or dangerous object detection result.

In some embodiments, the scene identification result includes at least one of: rainy day identification result, fog day identification result, sandstorm identification result, flood identification result, typhoon identification result, cliff identification result, steep slope identification result, mountain risk road identification result, or light identification result.

In some embodiments, the obstacle number detection result includes at least one of: number of detected pedestrians, number of detected motor vehicles, number of detected non-motor vehicles, or number of detected other objects.

In some embodiments, the confidence degree obtaining unit 31 includes:

an environment detecting module, configured to respectively detect at least one vehicle driving environment according to the data collected by the sensor arranged in the vehicle to obtain a confidence degree of at least one detection result, each of the at least one vehicle driving environment corresponding to a confidence degree of at least one detection result; and

an environment confidence degree determining module, configured to for each of the at least one vehicle driving environment, determine the confidence degree of the detection result for the vehicle driving environment from the confidence degree of the at least one detection result corresponding to the vehicle driving environment.

In some embodiments, the sensor may include, but not limited to, a camera, and the collected data may be images, for example, when the camera is set in the front of the vehicle, the collected images are images in front of the vehicle. An image of the vehicle-related environmental information can be obtained with the sensor. Alternatively, the images can be processed by a deep neural network to obtain a confidence degree for each vehicle driving environment. The confidence degree for the vehicle driving environment indicates a probability that a particular situation occurs in the vehicle driving environment, for example, in a case that a lane line, a stop line, or a road intersection is not identified in road information, respective confidence degrees are respectively obtained, and the maximum confidence degree in the respective confidence degrees is taken as the confidence degree of the road information, that is, the confidence degree to which the current road identification is obstructed can be determined. When the likelihood that the road identification is obstructed is larger, it indicates that the safety level is lower.

In some embodiments, the detection result for the vehicle driving environment includes at least one of: road segmentation result, object detection result, or scene identification result;

the environment detecting module is configured to: process the data collected by the sensor by using a deep neural network to obtain a detection result for the at least one vehicle driving environment; for each of the at least one vehicle driving environment, determine at least one initial confidence degree of each detection result based on the detection result for the vehicle driving environment, each of the at least one vehicle driving environment corresponding to at least one detection result; obtain an average confidence degree of the detection result within a defined time period based on the at least one initial confidence degree of the detection result; and determine the confidence level for each detection result based on the average confidence level.

Alternatively, the detection result for the vehicle driving environment comprises obstacle number detection result;

the environment detecting module is configured to: process the data collected by the sensor by using a deep neural network to obtain at least one obstacle number detection result; based on each of the at least one obstacle number detection result, determine a number of obstacles belonging to each category; for each category, average the number of obstacles belonging to the category within a defined time period to obtain an average number of obstacles belonging to the category; and obtain a confidence degree corresponding to each of the at least one obstacle number detection result based on the average number.

In some embodiments, when obtaining the confidence degree corresponding to each obstacle category based on the average number, the environment detecting module is configured to: divide the average number by a defined number threshold for an obstacle category corresponding to the average number to obtain a quotient corresponding to the obstacle category; and numerically limit the quotient corresponding to the obstacle category to obtain the confidence degree corresponding to each obstacle category.

In some embodiments, the environment confidence degree determining module is configured to: for each of the at least one vehicle driving environment, determine a maximum in the confidence degree of the at least one detection result corresponding to the vehicle driving environment as the confidence degree of the detection result for the vehicle driving environment.

In some embodiments, the sensor includes a camera.

The working process, the configuration manner, and the corresponding technical effects of the intelligent driving control apparatus provided by any embodiment of the present disclosure can be referenced to the specific description of the described corresponding method embodiments of the present disclosure, and will not be described herein again for brevity.

According to another aspect of the embodiments of the present disclosure, a vehicle is provided, which includes the intelligent driving control apparatus according to the above embodiments.

According to another aspect of the embodiments of the present disclosure, there is provided an electronic device, comprising a processor, wherein the processor comprises the intelligent driving control apparatus according to any one of the above embodiments. In some embodiments, the electronic device may be an on-vehicle electronic device (i.e., an electronic device arranged in the vehicle).

According to another aspect of the embodiments of the present disclosure, there is provided an electronic device, including a memory storing executable instructions; and

a processor to communicate with the memory to execute the executable instructions to complete operations of the intelligent driving control method according to any of the above embodiments.

According to another aspect of the embodiments of the present disclosure, there is provided a computer storage medium for storing computer-readable instructions, wherein when the computer-readable instructions are executed, operations of the intelligent driving control method according to any of the above embodiments are performed.

According to another aspect of the embodiments of the present disclosure, there is provided a computer program product comprising computer-readable codes, wherein when the computer-readable codes are driving on a device, a processor in the device executes instructions for implementing the intelligent driving control method according to any of the above embodiments.

Embodiments of the present disclosure further provide an electronic device, for example, a mobile terminal, a personal computer (PC), a tablet computer, a server, and the like. Referring now to FIG. 4, which shows a schematic structural diagram of an electronic device 400 suitable for implementing a terminal device or a server according to embodiments of the present disclosure. As shown in FIG. 4, the electronic device 400 includes one or more processors, a communication unit, and the like. The one or more processors include, for example, one or more central processing units (CPUs) 401, and/or one or more dedicated processors. The dedicated processors may serve as an acceleration unit 413 and include, but not limited to, a graphics processing unit (GPU), a Field Programmable Gate Array (FPGA), a Digital Signal Processor (DSP) and other Application Specific Integrated Circuits (ASIC). The processor may perform various appropriate actions and processes according to executable instructions stored in ROM 402 or executable instructions loaded from a storage component 408 into RAM 403. The communication part 412 may include, but is not limited to, a network card, and the network card may include, but is not limited to, an IB (InfiniB and) network card.

The processor may communicate with ROM 402 and/or RAM 403 to execute the executable instructions, connect with the communication part 412 via the bus 404, and communicate with other target devices via the communication part 412, thereby completing operations corresponding to any method provided in the embodiments of the present disclosure. For example, the operations include obtaining a confidence degree of a detection result for at least one vehicle driving environment according to data collected by a sensor arranged in a vehicle; determining a driving safety level corresponding to the vehicle according to mapping relationships between confidence degrees and driving safety levels; and performing intelligent driving control on the vehicle according to the determined driving safety level.

The RAM 403 may further store various programs and data required for operations of the apparatus. The CPU 401, the ROM 402, and the RAM 403 are connected to each other via the bus 404. In the case where the RAM 403 is present, the ROM 402 is an optional module. The RAM 403 stores executable instructions, or writes executable instructions into the ROM 402 at runtime, and the executable instructions cause the CPU 401 to execute operations corresponding to the foregoing communication method. The input/output (I/O) interface 405 is also connected to the bus 404. The communication part 412 may be integrally arranged, or may be arranged to have a plurality of sub-modules (for example, a plurality of IB network cards) and be connected to a bus link.

The following components are connected to the I/O interface 405: an input component 406 including a keyboard, a mouse, and the like; an output component 407 including, for example, a cathode ray tube (CRT), a liquid crystal display (LCD), a speaker, and the like; a storage component 408 including a hard disk or the like; and a communication component 409 including a network interface card such as a Local Area Network (LAN) card, a modem or the like. The communication component 409 performs communication processing via a network such as Internet. The driver 410 is also connected to the I/O interface 405 as needed. A removable medium 411, such as a magnetic disk, an optical disk, a magneto-optical disk, a semiconductor memory, or the like, is mounted on the driver 410 as needed, so that a computer program read from the removable medium 411 is mounted on the memory component 408 as needed.

It should be noted that the architecture shown in FIG. 4 is merely an optional implementation, and during specific practice, the number and type of the components shown in FIG. 4 may be selected, deleted, added or replaced according to actual needs. Implementations such as separation setting or integration setting may also be adopted on different functional component settings, for example, the acceleration unit 413 and the CPU 401 may be separately set or the acceleration unit 413 may be integrated on the CPU 401, the communication part 412 may be separately set, or may be integrated on the CPU 401 or the acceleration unit 413, etc. These alternative embodiments all belong to the scope of protection of the present disclosure.

In particular, according to embodiments of the present disclosure, the processes described above with reference to the flowcharts may be implemented as computer software programs. For example, embodiments of the present disclosure include a computer program product including a computer program tangibly embodied in a machine readable medium. The computer program includes program codes for executing the method shown in the flowchart. The program codes may include instructions corresponding to the method steps provided in the embodiments of the present disclosure. For example, according to data collected by sensors provided on the vehicle, a confidence degree of a detection result for at least one vehicle driving environment is obtained; a driving safety level corresponding to the vehicle is determined according to mapping relationships between confidence degrees and driving safety levels; and intelligent driving control is performed on the vehicle according to the determined driving safety level. In such embodiments, the computer program may be downloaded and installed from the network through the communication component 409 and/or installed from the removable medium 411. When the computer program is executed by the CPU 401, the operations of the above-described function defined in the method of the present disclosure are performed.

Various embodiments in the present description are described in a progressive manner, each embodiment focuses on the differences from other embodiments, and the same or similar parts between various embodiments may be referred to for each other. For the system embodiment, since the system substantially corresponds to the method embodiment, the description is relatively simple, and reference may be made to some of the description of the method embodiment.

The methods and apparatuses of the present disclosure may be implemented in multiple ways. For example, the methods and apparatuses of the present disclosure may be implemented by software, hardware, firmware, or any combination of software, hardware, firmware. The above-mentioned order for steps of the method is for illustration only, and the steps of the method of the present disclosure are not limited to the order specifically described above, unless otherwise specifically described. Furthermore, in some embodiments, the present disclosure may also be embodied as programs recorded in a recording medium. The programs include machine-readable instructions for implementing the method according to the present disclosure. Accordingly, the present disclosure further covers a recording medium storing programs for executing the method according to the present disclosure.

The descriptions of the present disclosure are given for purposes of example and description and are not intended to be exhaustive or to limit the present disclosure to the disclosed form. Multiple modifications and variations will be apparent to those skilled in the art. The embodiments are chosen and described for better illustration of the principles and practical applications of the present disclosure, and to enable those skilled in the art to understand the present disclosure to design various embodiments with various modifications suitable for a particular use.

What is claimed is:

1. An intelligent driving control method, comprising:
obtaining a confidence degree of a detection result for at least one vehicle driving environment according to data collected by a sensor arranged in a vehicle;
determining a driving safety level corresponding to the vehicle according to mapping relationships between confidence degrees and driving safety levels; and
performing an intelligent driving control on the vehicle according to the determined driving safety level.

2. The method according to claim 1, further comprising:
displaying information associated with the determined driving safety level; and/or
sending the information associated with the determined driving safety level.

3. The method according to claim 1, wherein determining the driving safety level corresponding to the vehicle according to the mapping relationships between confidence degrees and driving safety levels comprises:
according to the mapping relationships between confidence degrees and driving safety levels, respectively mapping the confidence degree of the detection result for the at least one vehicle driving environment to obtain at least one driving safety level; and
determining a lowest driving safety level in the at least one driving safety level as the driving safety level corresponding to the vehicle.

4. The method according to claim 1, wherein the intelligent driving control comprises:
performing a switching control of driving modes of the vehicle, wherein the driving modes comprise at least two of: an automatic driving mode, a manual driving mode, or an auxiliary driving mode.

5. The method according to claim 4, wherein the driving safety levels comprise at least two of: a low safety level, a medium-low safety level, a medium safety level, or a high safety level.

6. The method according to claim 5, wherein performing an intelligent driving control on the vehicle according to the determined driving safety level comprises:
in response to the driving safety level being the low safety level or the medium-low safety level, controlling the vehicle to be at the manual driving mode, and/or sending out a prompt and controlling the vehicle to be at the manual driving mode, the auxiliary driving mode, or the automatic driving mode according to feedback information; and/or
in response to the driving safety level being the medium safety level or the high safety level, controlling the vehicle to be at the automatic driving mode, or controlling the vehicle to be at the manual driving mode or the auxiliary driving mode according to feedback information.

7. The method according to claim 1, wherein
the vehicle driving environment comprises at least one of: road, object, scene, or number of obstacles; and
the detection result for the vehicle driving environment comprises at least one of: a road segmentation result, an object detection result, a scene identification result, or an obstacle number detection result.

8. The method according to claim 7, wherein the road segmentation result comprises at least one of:
a lane line segmentation result, a stop line segmentation result, or a road intersection segmentation result.

9. The method according to claim 7, wherein the object detection result comprises at least one of:
a pedestrian detection result, a motor vehicle detection result, a non-motor vehicle detection result, an obstacle detection result, or a dangerous object detection result.

10. The method according to claim 7, wherein the scene identification result comprises at least one of:
a rainy day identification result, a fog day identification result, a sandstorm identification result, a flood identification result, a typhoon identification result, a cliff identification result, a steep slope identification result, a mountain risk road identification result, or a light identification result.

11. The method according to claim 7, wherein the obstacle number detection result comprises at least one of:
a number of detected pedestrians, a number of detected motor vehicles, a number of detected non-motor vehicles, or a number of detected other objects.

12. The method according to claim 1, wherein obtaining the confidence degree of the detection result for the at least one vehicle driving environment according to data collected by the sensor arranged in the vehicle comprises:
respectively detecting at least one vehicle driving environment according to the data collected by the sensor arranged in the vehicle to obtain a confidence degree of at least one detection result, each of the at least one vehicle driving environment corresponding to a confidence degree of at least one detection result; and
for each of the at least one vehicle driving environment, determining the confidence degree of the detection result for the vehicle driving environment from the confidence degree of the at least one detection result corresponding to the vehicle driving environment.

13. The method according to claim 12, wherein
the detection result for the vehicle driving environment comprise at least one of: a road segmentation result, an object detection result, or a scene identification result; and
respectively detecting at least one vehicle driving environment according to the data collected by the sensor arranged in the vehicle to obtain the confidence degree of at least one detection result comprises:
processing the data collected by the sensor by using a deep neural network to obtain the detection result for the at least one vehicle driving environment;
for each of the at least one vehicle driving environment, determining at least one initial confidence degree of each detection result based on the detection result for the vehicle driving environment, each of the at least one vehicle driving environment corresponding to at least one detection result;
obtaining an average confidence degree of the detection result within a defined time period based on the at least one initial confidence degree of the detection result; and
determining the confidence level for each detection result based on the average confidence level.

14. The method according to claim 12, wherein
the detection result for the vehicle driving environment comprises an obstacle number detection result; and
respectively detecting at least one vehicle driving environment according to the data collected by the sensor arranged in the vehicle to obtain the confidence degree of at least one detection result comprises:
processing the data collected by the sensor by using a deep neural network to obtain at least one obstacle number detection result;
based on each of the at least one obstacle number detection result, determining a number of obstacles belonging to each category;
for each category, averaging the number of obstacles belonging to the category within a defined time period to obtain an average number of obstacles belonging to the category; and
obtaining a confidence degree corresponding to each of the at least one obstacle number detection result based on the average number.

15. The method according to claim 14, wherein obtaining the confidence degree corresponding to each obstacle category based on the average number comprises:
dividing the average number by a defined number threshold for an obstacle category corresponding to the average number to obtain a quotient corresponding to the obstacle category; and
numerically limiting the quotient corresponding to the obstacle category to obtain the confidence degree corresponding to each obstacle category.

16. The method according to claim 12, wherein for each of the at least one vehicle driving environment, determining the confidence degree of the detection result for the vehicle driving environment from the confidence degree of the at least one detection result corresponding to the vehicle driving environment comprises:
for each of the at least one vehicle driving environment, determining a maximum in the confidence degree of the at least one detection result corresponding to the vehicle driving environment as the confidence degree of the detection result for the vehicle driving environment.

17. The method according to claim 1, wherein the sensor comprises a camera.

18. An electronic device, comprising:
a memory storing executable instructions; and
a processor to communicate with the memory to execute the executable instructions to complete operations comprising:
obtaining a confidence degree of a detection result for at least one vehicle driving environment according to data collected by a sensor arranged in a vehicle;
determining a driving safety level corresponding to the vehicle according to mapping relationships between confidence degrees and driving safety levels; and
performing an intelligent driving control on the vehicle according to the determined driving safety level.

19. The electronic device according to claim 18, wherein determining the driving safety level corresponding to the vehicle according to the mapping relationships between confidence degrees and driving safety levels comprises:
according to the mapping relationships between confidence degrees and driving safety levels, respectively mapping the confidence degree of the detection result for the at least one vehicle driving environment to obtain at least one driving safety level; and
determining a lowest driving safety level in the at least one driving safety level as the driving safety level corresponding to the vehicle.

20. A non-transitory computer storage medium for storing computer-readable instructions, wherein when the computer-readable instructions are executed by a processor, the processor is caused to perform operations comprising:
obtaining a confidence degree of a detection result for at least one vehicle driving environment according to data collected by a sensor arranged in a vehicle;
determining a driving safety level corresponding to the vehicle according to mapping relationships between confidence degrees and driving safety levels; and
performing an intelligent driving control on the vehicle according to the determined driving safety level.
